(19) United States
(12) Patent Application Publication
(10) Pub. No.: US 2012/0059903 A1
(43) Pub. Date: Mar. 8, 2012

(54) METHOD AND APPARATUS FOR PROCESSING SENSORY INFORMATION IN WIRELESS SENSOR NETWORK

(75) Inventor: Min Su KIM, Hwaseong-si (KR)

(73) Assignee: SAMSUNG ELECTRONICS CO. LTD., Suwon-si (KR)

(21) Appl. No.: 13/224,610

(22) Filed: Sep. 2, 2011

(30) Foreign Application Priority Data
Sep. 6, 2010 (KR) 10-2010-0086917

(51) Int. Cl. G06F 15/16

(52) U.S. Cl. 709/217

(57) ABSTRACT

A method and an apparatus for processing sensory information in a wireless sensor network are provided. The method includes determining at least one of sensor gateways as a serving sensor gateway to manage a target region in response to a sensory information request from a server, collecting the sensory information by means of at least one sensor node connected to the serving sensor gateway, and transmitting the collected sensory information to the server.

### PRIORITY

This application claims the benefit under 35 U.S.C. §119(a) of a Korean patent application filed on Sep. 6, 2010 in the Korean Intellectual Property Office and assigned Serial No. 10-2010-0086917, the entire disclosure of which is hereby incorporated by reference.

### BACKGROUND OF THE INVENTION

1. Field of the Invention

The present invention relates to a Wireless Sensor Network (WSN). More particularly, the present invention relates to a method and an apparatus for processing sensory information in a WSN.

2. Description of the Related Art

A wireless sensor network is a network including a plurality of sensor nodes having computing and radio communication abilities to collect data autonomously. The wireless sensor network can be used to provide the detected data collected by the sensor nodes for remote monitoring and controlling. The wireless sensor network supports Machine to Machine (M2M) communication among the sensor nodes.

The wireless sensor network is a promising technology for ubiquitous service. The ubiquitous service is conceived for the user to use the computing and communication services as if consuming water and air without awareness of their existence. That is, all the devices, such as a Personal Computer (PC), a navigator, a television (TV), an electronic appliance, a game console, and a portable terminal can be equipped with a sensor to form a wireless sensor network. Such a wireless sensor network is referred to as Ubiquitous Sensor Network (U-Sensor Network or USN).

However, the wireless sensor network of the related art has a drawback in that, as the network expands, it becomes difficult to collect the detected data of the sensor nodes. This is because it is difficult to determine and manage all the large number of sensor nodes of the wireless sensor network. After all, the expanded size is likely to cause a problem in acquiring a specific area of the wireless sensor network.

Therefore, a need exists for a method and an apparatus that is capable of facilitating data detection in a wireless sensor network.

### SUMMARY OF THE INVENTION

Aspects of the present invention are to address at least the above-mentioned problems and/or disadvantages and to provide at least the advantages described below. Accordingly, an aspect of the present invention is to provide a method and an apparatus that is capable of facilitating data detection in a wireless sensor network.

Another aspect of the present invention is to provide a method and an apparatus that is capable of collecting the sensory information of a target area without determining per-node locations.

In accordance with an aspect of the present invention, a method for processing sensory information in a wireless sensor network is provided. The method includes determining at least one of sensor gateways as a serving sensor gateway to manage a target region in response to a sensory information request from a server, collecting the sensory information by means of at least one sensor node connected to the serving sensor gateway, and transmitting the collected sensory information to the server.

In an exemplary implementation, the sensory information collected by the at least one sensor node may be stored. The method may further include determining whether the requested sensory information is matched with a predefined reuse range and transmitting, when the sensory information is matched with the reuse range, the store sensory information to the server.

In accordance with another aspect of the present invention, an apparatus for processing sensory information in a wireless sensor network is provided. The apparatus includes a memory unit for storing location information of a plurality of sensor gateways, a communication unit for establishing connections with sensor gateways and a server, a determining part for determining at least one of the sensor gateways as a serving sensor gateway in response to a sensory information request from the server, and a collecting part for collecting the sensory information by means of at least one sensor node connected to the serving gateway.

In an exemplary implementation, the memory unit stores the sensory information collected by the sensor nodes. The determining part determines whether a requested sensory information is matched with a predefined reuse range and controls, when the requested sensory information is matched with a predefined reuse range, to transmit the stored sensory information to the server when the requested sensory information is matched with a predefined reuse range.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a topology of a wireless sensor network according to an exemplary embodiment of the present invention;

FIG. 2 is a block diagram illustrating a configuration of a sensory information processing apparatus according to an exemplary embodiment of the present invention;

FIG. 3 is a flowchart illustrating a method for processing sensory information according to an exemplary embodiment of the present invention;

FIG. 4 is a flowchart illustrating a sensor gateway determination step according to a first exemplary embodiment of the present invention;

FIG. 5 is diagram illustrating a principle for selecting a sensor gateway through a sensor gateway determination process according to an exemplary embodiment of the present invention;

FIG. 6 is a flowchart illustrating a sensor gateway determination step according to a second exemplary embodiment of the present invention;

FIG. 7 is a diagram illustrating a principle for selecting a sensor gateway through a sensor gateway determination process according to an exemplary embodiment of the present invention;

FIG. 8 is a flowchart illustrating a sensor gateway determination step according to a third exemplary embodiment of the present invention;

FIG. 9 is a diagram illustrating a principle for selecting a sensor gateway through a sensor gateway determination process according to an exemplary embodiment of the present invention;

FIG. 10 is a flowchart illustrating a sensor gateway determination step according to a fourth exemplary embodiment of the present invention;

FIG. 11 is a diagram illustrating a principle for selecting a sensor gateway through a sensor gateway determination process according to an exemplary embodiment of the present invention;

FIG. 12 is a flowchart illustrating a sensor gateway determination step according to a fifth exemplary embodiment of the present invention;

FIG. 13 is a flowchart illustrating a sensory information storage step according to an exemplary embodiment of the present invention; and

FIG. 14 is a diagram illustrating a principle for storing sensory information through a sensory information storage process according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

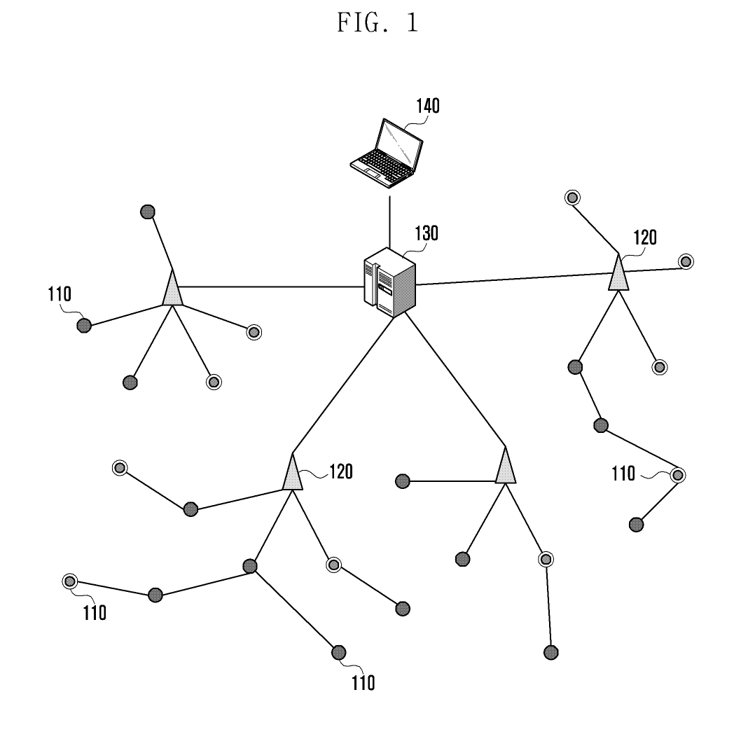

FIGS. 1 through 14, described below, and the various exemplary embodiments of the present invention provided are by way of illustration only and should not be construed in any way that would limit the scope of the present invention. Those skilled in the art will understand that the principles of the present disclosure may be implemented in any suitably arranged communications system. The terms used to describe various exemplary embodiments of the present invention provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is a diagram illustrating a topology of a wireless sensor network according to an exemplary embodiment of the present invention.

Referring to FIG. 1, a wireless sensor network includes a plurality of sensor nodes 110, a plurality of sensor gateways 120, a core platform 130, and an application server 140.

Each sensor node 110 collects sensory information from its environment. Each sensor node 100 is monitoring a detection coverage region to collect the sensory information. Some of the sensor nodes 110 can be connected in a hierarchical structure. Each sensor node 110 can be mobile or fixed at a position. In addition, each sensor node can be deployed independently or attached to a specific object. For example, the sensor node 110 can be attached to a Personal Computer (PC), a navigator, a television, electronic appliances, a game console, and a portable terminal. Each sensor node 110 can be configured to collect the sensory information periodically or in response to an external request.

The sensory information is the information of a property of the environment. The sensory information can correspond to the physical context, such as temperature, humidity, traffic state, brightness, noise, and the like. The sensory information can also correspond to the temporal context, such as an hour, a week, a month, a season, and the like. The sensory information can also correspond to the user context, such as a user profile and a location. The sensory information can also correspond to the computing context, such as a connection state and a communication bandwidth. Such sensory information can include at least one of the identity information of the sensor node 110, sensory location information, and sensory time information.

The sensor gateways 120 relay the sensory information from the sensor nodes 110. Each sensor gateway 120 is connected to at least one sensor node 110 and supports communication among the sensor nodes 110. Each sensor gateway 120 stores the information on the locations of the connected sensor nodes 110. The sensor gateways 120 can support the Internet Protocol-based (IP-based) communication among the sensor nodes 110. That is, each sensor gateway 120 has a gateway coverage region as the union of the coverage areas of the connected sensor nodes 110.

The core platform 130 is an entity for processing the sensory information received from the sensor nodes 110 and collects and manages the sensory information. The core platform 130 connects the sensory information from the sensor nodes 110 via the sensor gateways 120. The core platform 130 can perform IP-based communication with the sensor nodes 110 via the sensor gateways 120. The core platform 130 stores the information on the locations of the sensor gateways 120. With this location information, the core platform 130 can communicate with the sensor gateways 120 selectively to collect the sensory information of the sensor nodes 110 in a specific region. The core platform 130 can also store and manage the sensory information per sensor node 110. That is, the core platform 130 controls the whole coverage region including the gateway coverage regions of the sensor gateways 120.

The application server 140 makes use of the sensor information of the sensor nodes 110. The application server 140 can request the core platform 130 for sensory information and receives the sensory information from the core platform 130. The application server 140 can perform IP-based communication with the core platform 130. The application server 140 can request the core platform 130 to transmit the sensory information about a specific region. In order to request for the information on a specific region, the application server 140 can send the core platform 130 a query message including a Target Area (TA) indicating a specific region. The application server 140 can also unite the sensory information for special application.

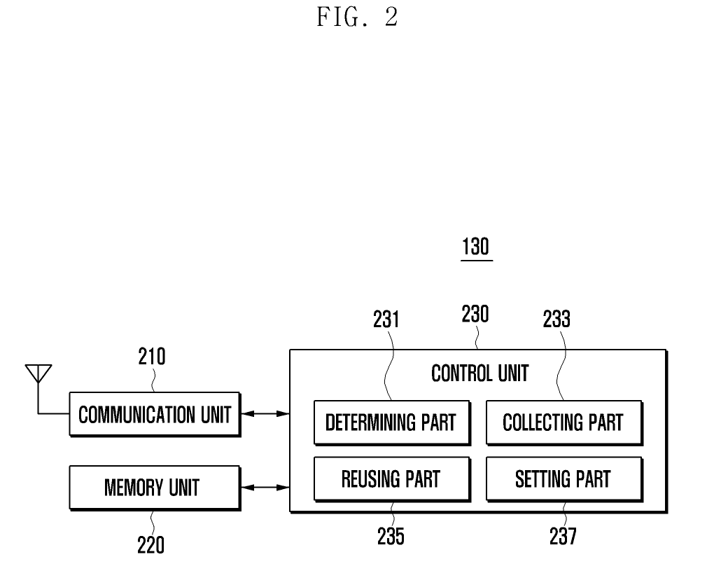

FIG. 2 is a block diagram illustrating a configuration of a sensory information processing apparatus according to an exemplary embodiment of the present invention.

Referring to FIG. 2, the sensory information processing apparatus or core platform 130 includes a communication unit 210, a memory unit 220, and a control unit 230.

The communication unit 210 is responsible for the communication function of the core platform 130. The communication unit 210 exchanges signals with the sensor gateways 120 and application server 140. That is, the communication unit 210 receives a sensory information request signal from the application server 140 and transmits the requested sensory information to the application server 140. The communication unit 210 can also forward the sensory information request signal to the sensor gateway 120 and receives the sensory information from the sensor gateway 120 in response to the request signal.

The memory unit 220 includes a program memory and a data memory. The program memory stores the program related to the operations of the core platform 130 and the program for collecting and managing the sensory information. The data memory stores the data generated by the application programs. The memory unit 220 stores the location information of the sensor gateways 120. The memory unit 220 can also store the information of reuse range for determining whether to reuse the sensory information per sensor node.

The control unit 230 is responsible for controlling overall operations of the core platform 130 and manages the sensory information.

If a request for the sensory information of a target region is received from the application server 140, the control unit 230 collects the sensory information from the sensor nodes 110 in the target region. The control unit 230 can reuse the sensory information of the sensor nodes 110. The control unit 230 can transmit the sensory information corresponding to the target region to the application server 140 and may include a determining part 231, a collecting part 233, a reusing part 235, and a setting part 237.

The determining part 231 determines at least one of sensor gates 120 having their own gateway coverage regions. At this time, the determining part 231 compares the location information of the sensor gateways 120 with the target region. The determining part 231 selects at least one of the sensor gateways 120 corresponding to the target region and configures the selected sensor gateways 120 into a Target Gateway Set (TGS). The determining part 231 determines whether to collect or reuse the sensory information according to the reuse range, i.e., determines whether to reuse the sensory information.

The collecting part 233 collects the sensory information from the sensor nodes 110 via the sensor gateways 120. The collecting part 233 requests at least one of the sensor gateways 120 for the sensory information by referencing the TGS and receives the sensory information from the sensor gateways 120. The collecting part 233 transmits the sensory information to the application server 140 and stores the sensory information in the memory unit 220.

The reuse part 235 searches the memory unit 220 for the sensory information of the sensor node 110 and reuses the found sensory information. The reuse part 235 also transmits the sensory information to the application server 140.

The setting part 237 calculates the reuse range using the sensory information per sensor node 110 and sets the reuse range. The setting part 237 can calculate the reuse range according to the time information in the sensory information of one sensor node 110. The setting part 237 can also calculate the reuse range according to the location information in the sensory information of multiple sensor nodes 110. The setting part 237 can store the reuse range in the memory unit 220.

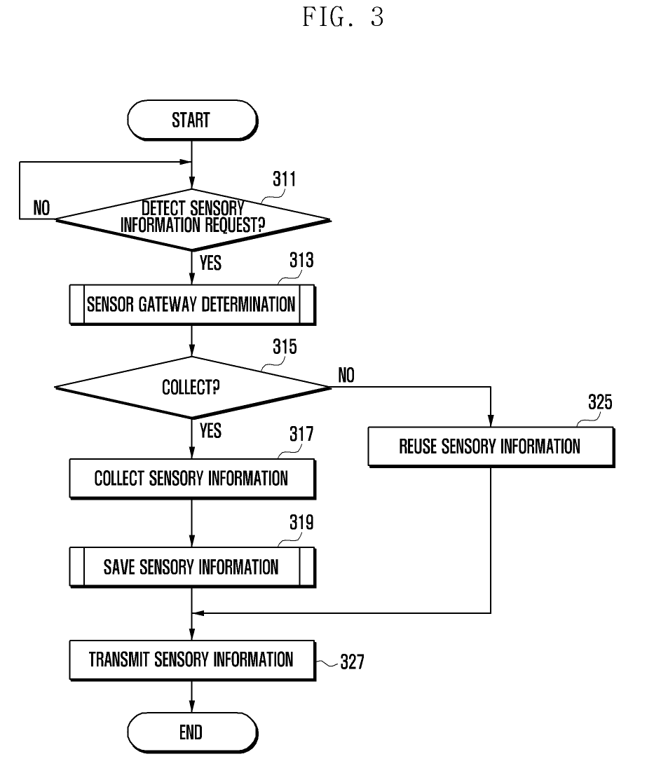

FIG. 3 is a flowchart illustrating a method for processing sensory information according to an exemplary embodiment of the present invention.

Referring to FIG. 3, in the sensory information processing method, the control unit 230 is monitoring to detect a sensory information request from the application server 140 at step 311. The application server 140 requests for the sensory information on a target region. Here, the target region can be a part of the entire coverage region of the core platform 130. If it is determined at step 311 that a sensory information request is detected, the control unit 230 determines a sensor gateway 120 at step 313. That is the control unit 230 selects one of the sensor gateways 120 having respective coverage regions. The sensor gateway determination step is described below.

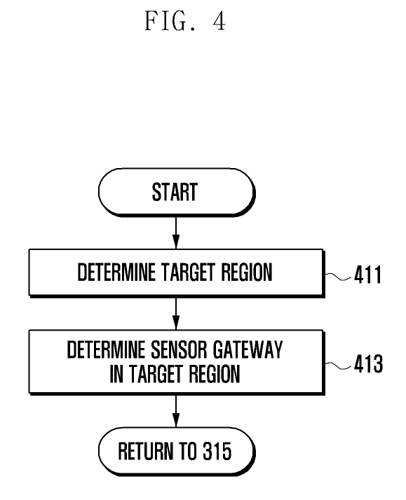

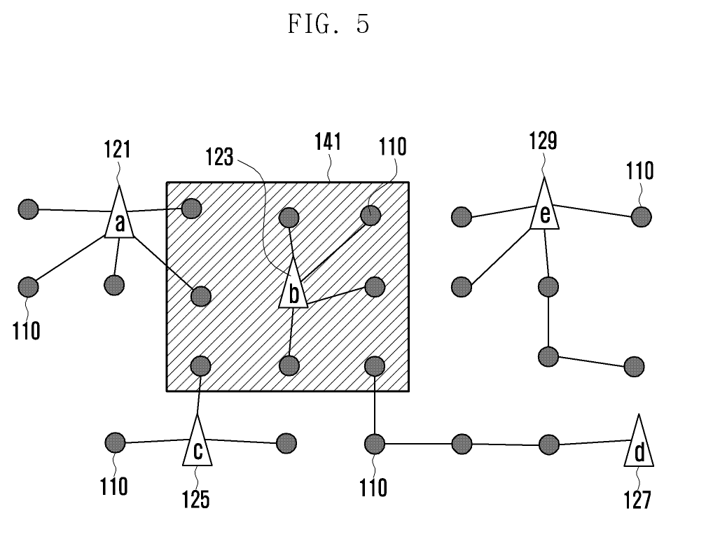

FIG. 4 is a flowchart illustrating a sensor gateway determination step according to a first exemplary embodiment of the present invention. FIG. 5 is diagram illustrating a principle for selecting a sensor gateway through a sensor gateway determination process according to an exemplary embodiment of the present invention.

Referring to FIGS. 4 and 5, in the sensor gateway determination process, the control unit 230 first determines the target region at step 411. At this time, the control unit 230 analyzes the sensing information request transmitted by the application server 140 to identify the target region. Thereafter, the control unit 230 determines the sensor gateway 120 in the target region at step 413 and returns the procedure to step 315 of FIG. 3. That is, the control unit 230 compares the target region with the location information of each sensor gateway 120. The control unit 230 determines whether any sensor gateway is located in the target region by referencing the location information per sensor gateway 120. The control unit 230 selects the sensor gateways 120 in the target region and configures the selected gateways 120 into a TGS.

For example, there can be the first gateway 121, the second gateway 123, the third gateway 125, the fourth gateway 127, and fifth gateway 129 as the serving gateways in the entire region of the core platform 130. At this time, the control unit 230 can compare the locations of the first gateway 121, the second gateway 123, the third gateway 125, the fourth gateway 127, and the fifth gateway 129 with each other. Since the location of the second gateway 123 is at least partially included in the target region 141, the control unit 230 determines the second gateway 123 as the TGS.

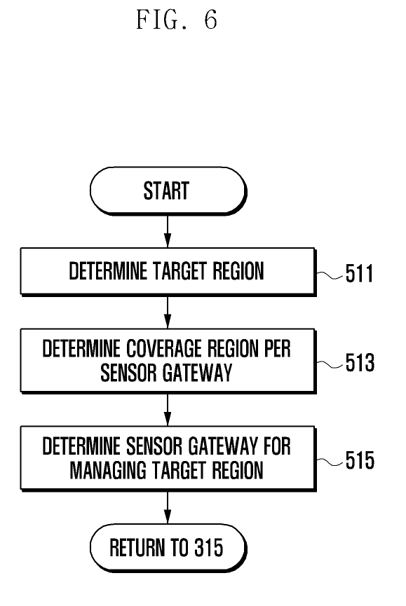

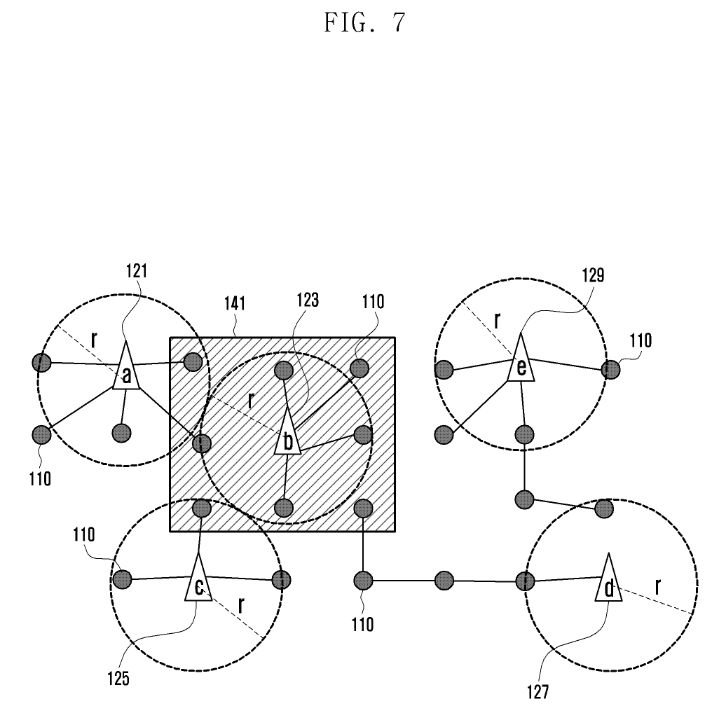

FIG. 6 is a flowchart illustrating a sensor gateway determination step according to a second exemplary embodiment of the present invention. FIG. 7 is a diagram illustrating a principle for selecting a sensor gateway through a sensor gateway determination process according to an exemplary embodiment of the present invention.

Referring to FIGS. 6 and 7, in the sensor gateway determination process, the control unit 230 first determines the target region at step 511. At this time, the control unit 230 analyzes the sensory information request transmitted by the application server 140 to identify the target region. Thereafter, the control unit 230 determines the coverage region per sensor gateway 120 at step 513. Since the control unit 230 does not have the location information of the sensor nodes 110, it is difficult to measure the coverage region of each sensor gateway 120. Thus, the control unit 230 uses the predefined radius information corresponding to the sensor gateways 120 to estimate the coverage region of each sensor gateway 120.

Thereafter, the control unit 230 determines the sensor gateway 120 managing the target region at step 515 and returns the procedure to step 315 of FIG. 3. That is, the control unit 230 determines whether the coverage region of each sensor gateway is at least partially included in the target region. If the coverage region of the sensor gateways 120 is at least partially included in the target region, the control unit 230 selects the sensor gateway 120 and adds the selected sensor gateway to the TGS.

For example, there can be the first gateway 121, the second gateway 123, the third gateway 125, the fourth gateway 127, and fifth gateway 129 as the serving gateways of the entire region of the core platform 130. At this time, the control unit 230 can compare the locations of the first gateway 121, the second gateway 123, the third gateway 125, the fourth gateway 127, and the fifth gateway 129 with each other. Since some part of the coverage regions of the first gateway 121, the second gateway 123, the third gateway 125, the fourth gateway 127, and the fifth gateway 129 is at least partially included in the target region 141, the control unit 230 can configure the first gateway 121, the second gateway 123, and the third gateway 125 into the target gateway set.

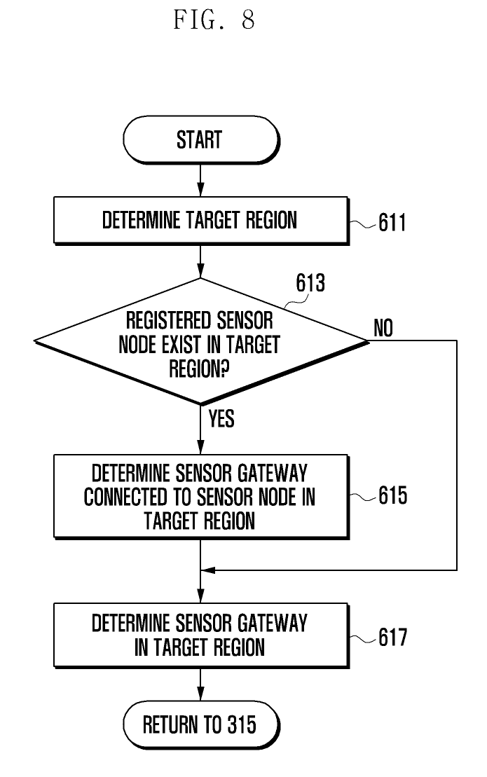

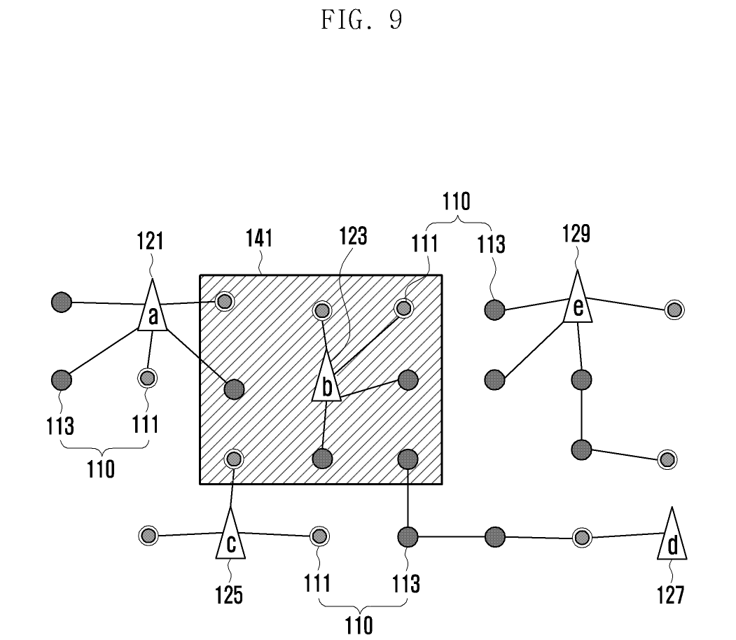

FIG. 8 is a flowchart illustrating a sensor gateway determination step according to a third exemplary embodiment of the present invention. FIG. 9 is a diagram illustrating a principle for selecting a sensor gateway through a sensor gateway determination process according to an exemplary embodiment of the present invention.

Referring to FIGS. 8 and 9, in the sensor gateway determination process, the control unit 230 first determines the target region at step 611. At this time, the control unit 230 analyzes the sensory information request transmitted by the application server 140 to identify the target region. Thereafter, the control unit 230 determines whether any sensor node 110 exists in the target region at step 613. That is, the control unit 230 determines whether at least one sensor node 110 is registered with the core platform 130. If at least one sensor node 110 is registered with the core platform, this means that location information per sensor node 110 can be stored in the memory unit 220. The control unit 230 compares the target region with the location of each sensor node 110. The control unit 230 also determines whether any sensor node exists in the target region by referencing the location information per sensor node 110.

If it is determined at step 613 that any sensor node 110 exists in the target region, the control unit 230 selects the sensor gateway 120 connected to the sensor node 110 located in the target region at step 615. That is, the control unit 230 selects at least one of the sensor gateways 120 connected to sensor nodes 110 located in the target region and adds the selected sensor gateway 120 to the target gateway set.

Thereafter, the control unit 230 selects one of the sensor gateways 120 in the target region as the serving sensor gateway at step 617 and returns the procedure to step 315 of FIG. 3. At this time, the control unit 230 compares the target region with the location information per sensor gateway 120. The control unit 230 determines whether the sensor gateway 120 is located in the target region by referencing the location information per sensor gateway 120. Thereafter, the control unit 230 selects the sensor gateway 120 located in the target region and adds the selected sensor gateway to the TGS. The control unit 230 can maintain and update the target gateway set.

For example, there can be the first gateway 121, the second gateway 123, the third gateway 125, the fourth gateway 127, and fifth gateway 129 as the serving gateways of the entire region of the core platform 130 as shown in FIG. 9. In the entire region of the core platform 130, the sensor nodes 110 can be discriminated into the registered sensor nodes 111 that are registered with the core platform 130 and the unregistered sensor nodes 113 that are not registered with the core platform 130. At this time, the control unit 230 compares the target region 141 with the location information of each registered node 111 to discover the registered sensor node 111 located in the target region 141. The control unit 230 can select the first gateway 121, the second gateway 123, and the third gateway 125 and adds the selected sensor gateways to the target gateway set. The control unit 230 can also compare the target region 141 with the location information of each of the first gateway 121, the second gateway 123, the third gateway 125, the fourth gateway 127, and the fifth gateway 129. In addition, the control unit 230 can select the second gateway 123 and adds the second gateway 123 to the target gateway set. In this manner, the control unit 230 can configure the first gateway 121, the second gateway 123, and the third gateway 125 into the target gateway set.

If no sensor node exists in the target region at step 613, the control unit 230 selects the sensor gateway 120 located in the target region as the serving sensor gateway at step 617 and returns the procedure to step 315 of FIG. 3. At this time, the control unit 230 compares the target region with the location information of each sensor gateway 120. The control unit 230 determines whether any sensor gateway 120 exists in the target region by referencing the location information per sensor gateway 120. The control unit 230 selects the sensor gateway 120 located in the target region and configures the selected sensor gateway 120 into the target gateway set.

Although the description is directed to the case where the control unit 230 retrieves the sensor gateway 120 corresponding to the sensor node 110 located in the target region and determines the retrieved sensor gateway 120 as the target region sensor gateway, exemplary embodiments of the present invention are not limited thereto. For example, exemplary embodiments of the present invention can be implemented in such a way that the control unit 230 discovers the sensor gateways 120 located in the target region and selects the sensor gateway corresponding to the sensor node 110 located in the target region as the target region sensor gateway. At this time, the control unit 230 selects the target region sensor network 120 and determines whether any sensor node 110 exists in the target region. If it is determined that any sensor node 110 exists in the target region, the control unit 230 selects the sensor gateway corresponding to the sensor node 110 located in the target region as the target region sensor gateway. In contrast, if it is determined that no sensor node exists in the target region, the control unit 230 returns the procedure to step 315 of FIG. 3.

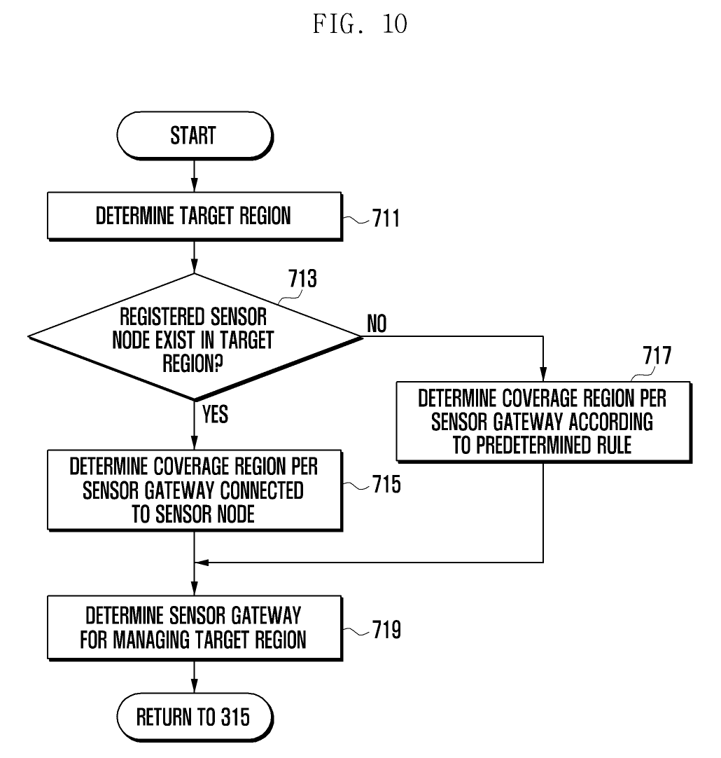

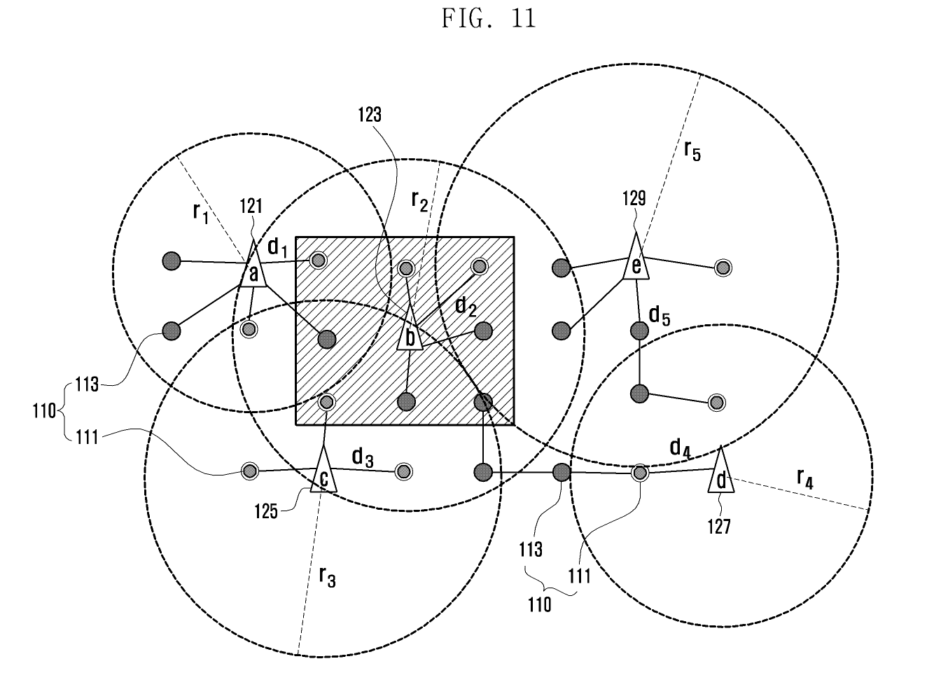

FIG. 10 is a flowchart illustrating a sensor gateway determination step according to a fourth exemplary embodiment of the present invention. FIG. 11 is a diagram illustrating a principle for selecting a sensor gateway through a sensor gateway determination process according to an exemplary embodiment of the present invention.

Referring to FIGS. 10 and 11, in the sensor gateway determination process, the control unit 230 first determines the target region at step 711. At this time, the control unit 230 analyzes the sensory information request transmitted by the application server 140 to identify the target region. Thereafter, the control unit 230 determines whether there is any sensor node registered at step 713. That is, the control unit 230 determines whether at least one sensor node is registered with the core platform 130. If any sensor node is registered, this means that the location information of the sensor node 110 can be stored in the memory unit 220.

If there is any sensor node registered with the core platform 130, the control unit 230 determines the coverage region of the sensor gateway 120 corresponding to the registered sensor node 110 at step 715. That is, the control unit 230 compares the location information of the sensor node 110 with the location information of each sensor gateway 120. Thereafter, the control unit 230 calculates the maximum distance (d) between the gateway 120 and the sensor node 110. The control unit 230 also calculates the radius of the sensor gateway 120 based on the distance information of individual sensor gateways 120. At this time, the control unit 230 can calculate the ratio of the sensor gateway 120 using Equation 1. By applying the radius per location of the sensor gateway 120, it is possible to estimate the coverage region of the sensor gateway 120.

r=C₁×d+C₂ [Equation 1]

where r denotes radius, d denotes distance, and C₁ and C₂ denote predefined constants.

If there is no sensor node registered with the core platform 130 at step 713, the control unit 230 determines the coverage region of each gateway 120 according to a predefined rule at step 717. In this case, since no location information of the sensor nodes 110 is stored, it is difficult for the control unit 230 to measure the coverage region of each sensor gateway 120. The control unit 230 applies predefined radius information in correspondence with the location of the sensor gateway 120 to estimate the coverage region of each sensor gateway 120.

Thereafter, the control unit 230 determines the sensor gateway 120 for managing the target region at step 719 and returns the procedure to step 315 of FIG. 3. That is, the control unit 230 determines whether there is any sensor gateway having a coverage region that is overlapped with the target region. If there is any sensor gateway having a coverage region that is overlapped with the target region, the control unit 230 adds the corresponding sensor gateway 120 to the target gateway set.

For example, there can be the first gateway 121, the second gateway 123, the third gateway 125, the fourth gateway 127, and fifth gateway 129 as the serving gateways of the entire region of the core platform 130 as shown in FIG. 11. In the entire region of the core platform 130, the sensor nodes 110 can be discriminated into the registered sensor nodes 111 that are registered with the core platform 130 and the unregistered sensor nodes 113 that are not registered with the core platform 130. At this time, the control unit 230 compares the target region 141 with the location information of each registered node 111 to discover the registered sensor node 111 located in the target region 141. Thereafter, the control unit 230 can determine the coverage regions of the first gateway 121, the second gateway 123, the third gateway 125, the fourth gateway 127, and the fifth gateway 129. The control unit 230 can also compare the coverage region of each of the first gateway 121, the second gateway 123, the third gateway 125, the fourth gateway 127, and the fifth gateway 129 with the target region 141. The control unit 230 can configure the first gateway 121, the second gateway 123, the third gateway 125, the fourth gateway 127, and the fifth gateway 129 into the target gateway set.

Referring to FIG. 11, d1 and r1 denote the distance between the first gateway 121 and the sensor node 110 and the radius of the coverage region of the first gateway 121, respectively, d2 and r2 denote the distance between the second gateway 123 and the sensor node 110 and the radius of the coverage region of the second gateway 123, respectively, d3 and r3 denote the distance between the third gateway 125 and the sensor node 110 and the radius of the coverage region of the third gateway 125, respectively, d4 and r4 denote the distance between the fourth gateway 127 and the sensor node 110 and the radius of the coverage region of the fourth gateway 127, respectively, and d5 and r5 denote the distance between the fifth gateway 129 and the sensor node 110 and the radius of the coverage region of the fifth gateway 129, respectively.

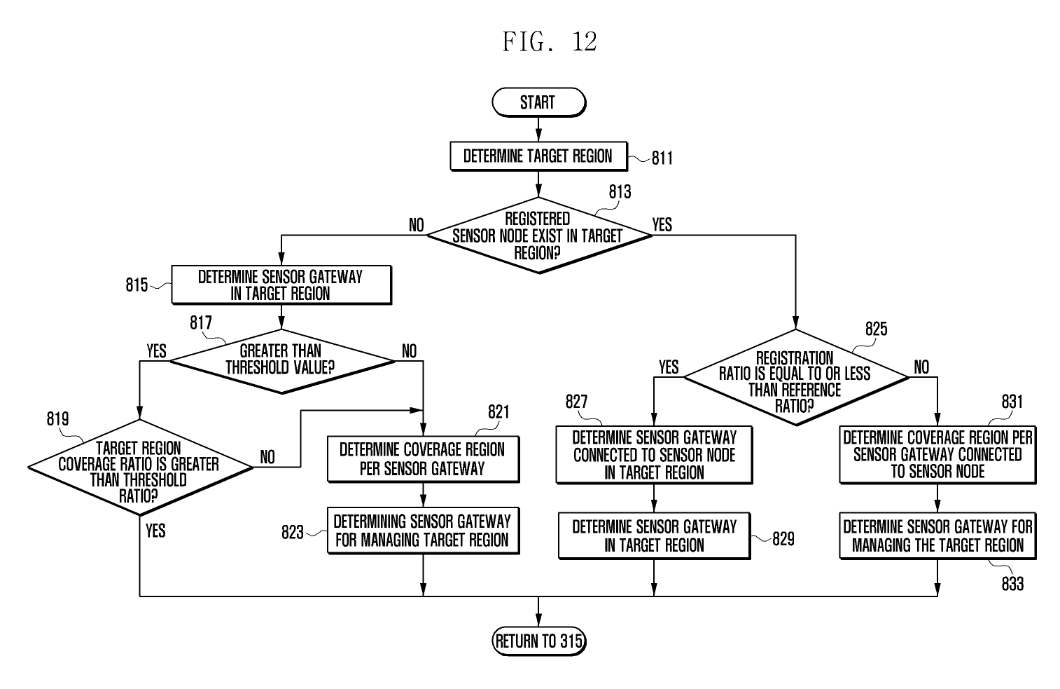

FIG. 12 is a flowchart illustrating a sensor gateway determination step according to a fifth exemplary embodiment of the present invention.

Referring to FIG. 12, in the sensor gateway determination process, the control unit 230 first determines the target region at step 811. At this time, the control unit analyzes the sensory information request transmitted by the application server 140 to identify the target region. Thereafter, the control unit 230 determines whether there is any sensor node registered at step 813. That is, the control unit 230 determines whether at least one sensor node 110 is registered with the core platform 130. If any sensor node is registered, this means that the location information of the sensor node 110 can be stored in the memory unit 220.

If it is determined at step 813 that there is no sensor node registered with the core platform 130, the control unit 230 discovers the sensor gateways 120 in the target region at step 815. At this time, the control unit 230 compares the target region with the location of each sensor gateway 120. The control unit 230 determines whether a sensor gateway 120 is located within the target region by referencing the location information of the sensor gateway 120. The control unit 230 selects the sensor gateways 120 located within the target region and adds the selected sensor gateways 120 to the TGS. Thereafter, the control unit 230 determines whether a number of the sensor gateways 120 located within the target region is equal to or greater than a predefined threshold value at step 817.

If it is determined at step 817 that the number of sensor gateways 120 is equal to or greater than the predefined threshold value, the control unit 230 determines whether the rate of the coverage region of the sensor gateways 120 to the target region is greater than a predefined threshold ratio at step 819. That is, the control unit 230 determines the coverage regions of the sensor gateways 120 within the target region. At this time, the control unit 230 applies the predefined radius information in correspondence with the location information per sensor gateway 120 so as to estimate the coverage region of each sensor gateway 120. The control unit 230 compares the coverage regions of the sensor gateways 120 with the target region to estimate the coverage ratio to the target region. The control unit 230 also compares the ratio of the coverage regions to the target region with a predefined ratio. If it is determined that the coverage ratio of the sensor networks within the target region is greater than the threshold ratio, the control unit 230 returns the procedure to step 315 of FIG. 3.

In contrast, if it is determined at step 817 that the number of sensor gateways 120 is less than the threshold value or if it is determined at step 819 that the coverage ratio of the sensor gateway 120 is equal to or less than the threshold ratio, the control unit 230 determines the coverage regions of individual sensor gateways 120 at step 821. That is, the control unit 230 applies the predefined radius information in correspondence with the location information of each sensor gateway 120 so as to estimate the coverage region of each sensor gateway 120. Thereafter, the control unit 230 determines the sensor gateway for managing the target region at step 823 and returns the procedure to step 315 of FIG. 3. At this time, the control unit 230 compares the target region with the coverage region of each sensor gateway 120. Thereafter, the control unit 230 determines whether the coverage region of each sensor gateway 120 is included in the target region. If the coverage region is included in the target region, the control unit 230 selects the sensor gateway 120 of which coverage region is at least partially included in the target region and adds the selected sensor gateway 120 to the target gateway set.

In contrast, if there is any sensor node registered with the core platform 130 at step 813, the control unit 230 determines whether a registration ratio of sensor nodes 110 is equal to or less than a predefined reference ratio at step 825. At this time, the registration ratio can be the ratio of the number of sensor nodes 110 registered with the core platform 130 to the number of sensor nodes supportable by the core platform 130.

If it is determined at step 825 that the registration ratio is equal to or less than the reference ratio, the control unit 230 discovers the sensor gateways 120 connected to the sensor nodes located within the target region at step 827. That is, the control unit 230 determines whether any sensor node 110 is located within the target region according to the location information of each sensor node 110. The control unit 230 then selects at least one of the sensor gateways 120 connected to the sensor nodes 110 located within the target region and adds the selected sensor gateway 120 to the target gateway set.

Thereafter, the control unit 230 determines the sensor gateway 120 located within the target region as the target region management sensor gateway at step 829 and returns the procedure to step 315 of FIG. 3. At this time, the control unit 230 compares the target region with the location information of each sensor gateway 120. The control unit 230 determines whether the sensor gateway 120 is located within the target region based on the location information of the sensor gateway 120. The control unit 230 selects the sensor gateway 120 located within the target region and adds the selected sensor gateway 120 to the target gateway set. The control unit 230 can maintain and update the target gateway set.

Although the description is directed to the case where the control unit 230 discovers the sensor gateways 120 corresponding to the sensor nodes 110 located within the target region and discovers the sensor gateway located within the target region, exemplary embodiments of the present invention are not limited thereto. That is, the control unit 230 can be configured to discover the sensor gateways 120 located within the target region and discover the sensor gateways 120 connected to the sensor nodes 110 located within the target region.

In contrast, if it is determined at step 825 that the registration ratio is greater than the reference ratio, the control unit 230 determines the coverage region of each sensor gateway connected to the sensor node 110 at step 831. That is, the control unit 230 compares the location information of each sensor node 110 with the location information of sensor gateway 120 connected to the corresponding sensor node 110. The control unit 230 calculates the maximum distance between the sensor gateway 120 and the sensor node 110. The control unit 230 also calculates the coverage radius of each sensor gateway 120 according to the distance information of the sensor gateway 120. At this time, the control unit 230 can calculate the coverage radius of each sensor gateway 120 using Equation (1). By applying the radius information in correspondence with the location information of each sensor gateway 120, the control unit 230 can measure the coverage region of the gateway.

Thereafter, the control unit 230 determines the sensor gateway for managing the target region at step 833 and returns the procedure to step 315 of FIG. 3. That is, the control unit 230 determines whether the coverage region of each sensor gateway 120 is at least partially included in the target region. If the coverage region of each sensor gateway 120 is at least partially included in the target region, the control unit 230 selects the corresponding sensor gateway 120 and adds the selected sensor gateway 120 to the target gateway set.

Returning back to FIG. 3, after determining the sensor gateway, the control unit 315 determines whether it is necessary to collect sensory information via the sensor gateway at step 315. That is, the control unit 230 determines whether the sensory information corresponding to the sensor node 110 is connected to the sensor gateway 120. If there is no sensory information in the storage unit, the control unit 230 can control to collect sensory information. If there is the sensory information in the storage unit, the control unit 230 can determine whether to reuse the stored sensory information. If the sensory information is not in the reuse range, the control unit 230 can determine to collect sensory information. If the sensory information is in the reuse range, the control unit 230 can determine to reuse the stored sensory information.

Here, the reuse range can be a time interval. For example, when the reuse range is set to 30 seconds, the control unit 230 can determine whether the sensory information is collected within 30 seconds back from the current time. If it is determined that the sensory information is collected within the 30 seconds back from the current time, the control unit 230 determines the reuse of the sensory information and, otherwise, collection of new sensory information. The reuse range can also be a distance interval. For example, when the reuse range is set to 2 minutes, the control unit 230 can determine whether the sensory information is collected within the range of 2 minutes from the points corresponding to the target region based on the location information of the sensory information. If it is determined that the sensory information is collected in the range of 2 minutes from the points corresponding to the target region, the control unit 230 determines reuse of the sensory information and otherwise, collection of new sensory information.

If it is determined at step 315 that it is necessary to collect sensory information, the control unit 230 collects sensory information via the sensor gateway 120 at step 317. That is, the control unit 230 references the target gateway set and requests the sensor gateway 120 for the sensory information. The control unit 230 receives the sensory information transmitted by the sensor gateway 120 in response to the request. Thereafter, the control unit 230 stores the sensory information at step 319. A description of the sensory information storage step is provided below.

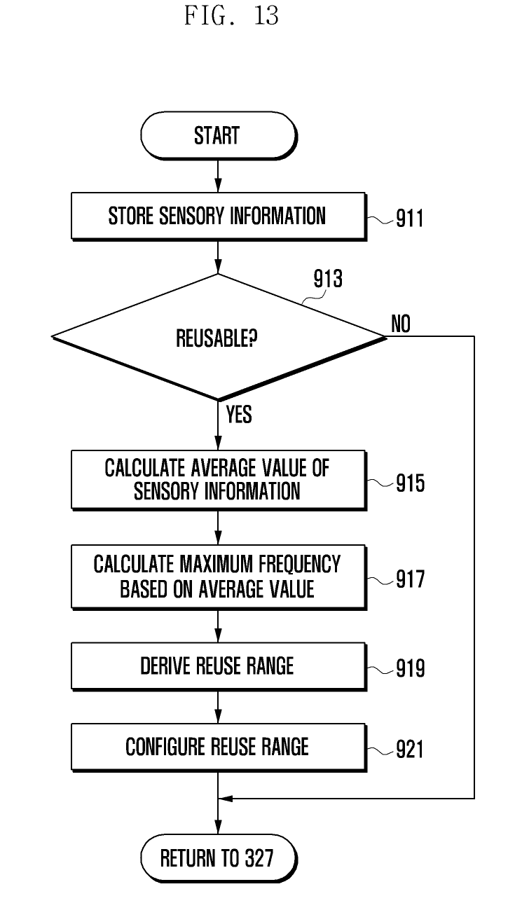

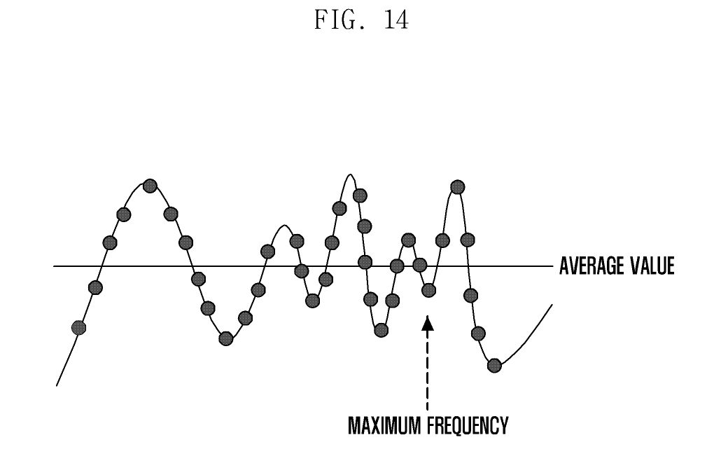

FIG. 13 is a flowchart illustrating a sensory information storage step according to an exemplary embodiment of the present invention. FIG. 14 is a diagram illustrating a principle for storing sensory information through a sensory information storage process according to an exemplary embodiment of the present invention.

Referring to FIGS. 13 and 14, in the sensory information storage process, the control unit 230 first stores the sensory information per sensor node at step 911. At this time, the control unit 230 can store the sensory information per sensor in an accumulative manner. The control unit 230 can also count a number of accumulations of the sensor information per sensor node. After storing the sensory information per sensor node, the control unit 230 determines whether the sensory information is reusable at step 913. At this time, the control unit 230 can verify the reusability by determining whether the number of accumulations of the sensory information per sensor node has reached a threshold value. If it is determined that the number of accumulations of the sensory information has reached the threshold value, the control unit 230 determines that the sensory information can be reused. In contrast, if it is determined that the number of accumulations of the sensory information has not reached the threshold value, the control unit 230 determines that the sensory information cannot be reused.

If it is determined at step 913 that the sensory information is not reusable, the control unit 230 returns the procedure to step 327 of FIG. 3. In contrast, if it is determined at step 913 that the sensory information is reusable, the control unit 230 calculates the average value of time information of the sensory information per sensor node. The control unit 230 can also calculate the average value of the location information of the sensory information in correspondence to the similar time information according to the time information of the sensory information. Thereafter, the control unit 230 calculates the maximum frequency of the sensing information per sensor node with reference to the average value at step 917. At this time, the control unit 230 can calculate the minimum value of the time interval between the sensory information according to the time information of the sensory information per sensor node. The control unit 230 can also calculate the minimum value of the distance interval between the sensory information according to the location information of the sensory information of multiple sensor nodes 110.

Thereafter, the control unit 230 derives the reuse range according to the maximum frequency at step 919. At this time, the control unit 230 can derive the reuse range from half of the maximum frequency. For example, when the minimum value of the interval between sensory information is 1 minute, the control unit 230 can set the reuse range to 30 minutes. In addition, when the distance interval between the sensory information is 4 minutes, the control unit 230 can set the reuse range to 2 minutes. Thereafter, the control unit 230 configures the reuse range at step 921 and returns the procedure to step 327 of FIG. 3. At this time, the control unit 230 deletes all the versions of the sensory information except for the most recently acquired sensory information. The control unit 230 can also initialize the number of accumulations of the sensory information per sensor node.

Returning to FIG. 3, if it is determined at step 315 that it is not necessary to collect sensory information, the control unit 230 determines to reuse the sensory information corresponding to the sensor gateway 120 at step 325. That is, the control unit 230 retrieves the sensory information of the sensor gateway 120 by referencing the target gateway set. The control unit 230 also retrieves the sensory information of the sensor gateway 120.

Finally, the control unit 230 transmits the sensory information to the application server 140 at step 327. That is, the control unit 230 transmits the sensory information corresponding to the target region to the application server 140.

Although the description is directed to the case where the core platform determines the sensor gateway and determines whether to collect the sensory information corresponding to the sensor gateway, exemplary embodiments of the present invention are not limited thereto. That is, exemplary embodiments of the present invention can be implemented in such a way that the core platform determines whether to collect sensory information and selects the sensor gateway for collecting sensory information. However, the core platform can determine whether to collect sensory information after the target region is determined. In this case, there is no need of determining the target region for collecting sensory information.

According to an exemplary embodiment of the present invention, the core platform can collect sensory information of a target region without determining and managing the locations of all sensor nodes in the wireless sensor network. Accordingly, it is possible for the core platform to collect the sensory information efficiently in the wireless sensor network. In any case, the core platform can provide the application server with the sensory information without collecting sensory information from the sensor nodes. As a consequence, it is possible to reduce the processing loads of the sensor nodes, sensor gateway, and core platform in the wireless sensor network.

As described above, the sensory information processing method and apparatus of the present invention is capable of collecting sensory information without determining the locations of all the sensor nodes in the wireless sensor network and, as a consequence, facilitates collecting the sensory information in the wireless sensor network.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for processing sensory information in a wireless sensor network, the method comprising:
determining at least one of sensor gateways as a serving sensor gateway to manage a target region in response to a sensory information request from a server;
collecting the sensory information by means of at least one sensor node connected to the serving sensor gateway; and
transmitting the collected sensory information to the server.

2. The method of claim 1, wherein the determining of the at least one of sensor gateways as the serving sensor gateway comprises:
determining a coverage region of each sensor gateway; and
selecting, when the coverage region is at least partially included in the target region, the corresponding sensor gateway.

3. The method of claim 1, wherein the determining of the at least one of sensor gateways as the serving sensor gateway comprises:
determining whether preregistered sensor nodes exist in the target region; and
selecting, when preregistered sensor nodes exist in the target region, one of the sensor gateways connected to the preregistered sensor nodes.

4. The method of claim 2, wherein the determining of the coverage region of each sensor gateway comprises determining, when preregistered sensor nodes exist in the target region, the coverage region of the sensor gateway based on a distance between one of sensor gateways connected to the preregistered sensor nodes and the corresponding sensor node.

5. The method of claim 1, wherein the sensory information collected by the at least one sensor node is stored in a memory unit, and the method further comprising:
determining whether the requested sensory information is matched with a predefined reuse range; and
transmitting, when the sensory information is matched with the reuse range, the stored sensory information to the server.

6. The method of claim 1, wherein the sensor nodes are connected in a hierarchical structure and are configured to collect the sensory information periodically or in response to an external request.

7. The method of claim 1, further comprising:
calculating, when the sensory information is collected a predefined number of times, a minimum value of time interval between sensing information; and
configuring a reuse range for determining whether at least some of the sensory information of the sensor node is reusable.

8. The method of claim 1, wherein the sensory information comprises at least one of identity information of the sensor node, sensory location information, sensory time information, temperature, humidity, traffic state, brightness, and noise.

9. The method of claim 1, further comprising:
calculating, when sensory information is collected by a plurality of sensor nodes, a minimum value of distance between the sensor nodes; and
configuring a reuse range for determining whether at least some of the sensory information of the sensor node is reusable.

10. An apparatus for processing sensory information in a wireless sensor network, the apparatus comprising:
a memory unit for storing location information of a plurality of sensor gateways;
a communication unit for establishing connections with sensor gateways and a server;
a determining part for determining at least one of the sensor gateways as a serving sensor gateway in response to a sensory information request from the server; and
a collecting part for collecting the sensory information by means of at least one sensor node connected to the serving gateway.

11. The apparatus of claim 10, wherein the determining part determines a coverage region of each sensor gateway and selects, when the coverage region is at least partially included in the target region, the corresponding sensor gateway.

12. The apparatus of claim 10, wherein the determining part determines whether preregistered sensor nodes exist in the target region and selects, when preregistered sensor nodes exist in the target region, one of the sensor gateways connected to the preregistered sensor nodes.

13. The apparatus of claim 11, wherein the determining part determines, when preregistered sensor nodes exist in the target region, the coverage region of the sensor gateway based on a distance between one of sensor gateways connected to the preregistered sensor nodes and the corresponding sensor node.

14. The apparatus of claim 10, wherein the memory unit stores the sensory information collected by the sensor nodes.

15. The apparatus of claim 10, wherein the sensor nodes are connected in a hierarchical structure and are configured to collect the sensory information periodically or in response to an external request.

16. The apparatus of claim 14, further comprising a reusing part for transmitting the stored sensory information to the server.

17. The apparatus of claim 14, further comprising a setting part for calculating, when the sensory information is collected a predefined number of times, a minimum value of time interval between sensing information and for configuring a reuse range for determining whether at least some of the sensory information of the sensor node is reusable.

18. The apparatus of claim 14, further comprising a setting part for calculating, when sensory information are collected by a plurality of sensor nodes, a minimum value of distance between the sensor nodes and for configuring a reuse range for determining whether at least some of the sensory information of the sensor node is reusable.

19. The apparatus of claim 10, wherein the sensory information comprises at least one of identity information of the sensor node, sensory location information, sensory time information, temperature, humidity, traffic state, brightness, and noise.
